(19) United States
(12) Patent Application Publication
(10) Pub. No.: US 2008/0233917 A1
(43) Pub. Date: Sep. 25, 2008

(54) Method for Implementing Charging in Intelligent Networks

(76) Inventors: Xiujuan Liu, Guangdong (CN); Junrong Xu, Guangdong (CN); Xiaodong Zhao, Guangdong (CN); Xuanmin Lu, Guangdong (CN); Haifeng Xu, Guangdong (CN)

Correspondence Address: LADAS & PARRY LLP, 224 SOUTH MICHIGAN AVENUE, SUITE 1600, CHICAGO, IL, 60604, US

(21) Appl. No.: 10/593,764

(22) PCT Filed: Mar. 22, 2005
(86) PCT No.: PCT/CN2005/000363

§ 371 Date: Jan. 26, 2007

(30) Foreign Application Priority Data
Mar. 24, 2004 (CN) 200410030400.3

(51) Int. Cl. H04M 11/00

(52) U.S. Cl. 455/406

(57) ABSTRACT

A method for implementing charging in intelligent networks is provided, including: Step a: configuring a first paid service account as an attached account to a second paid service account, and setting an interface for invoking services and interface for deducting fees for the second paid service; Step b: when the first paid service is to be used by the first paid service account, determining whether the first paid service account is configured as an attached account to the second paid service account, if yes, invoking the interface for invoking services to authenticate the second paid service account; if it is authenticated, performing Step c; otherwise, terminating the procedure; and Step c: when the first paid service has been used by the first paid service account, calculating the fee and invoking the interface for deducting fees to deduct the fee from the second paid service account.

### FIELD OF THE INVENTION

The present invention relates to the field of communications, and more particularly, to a method for implementing charging in intelligent networks (IN).

### BACKGROUND OF THE INVENTION

Intelligent networks are classified, in terms of network protocols, as fixed intelligent networks, Global System for Mobile communications (GSM) intelligent networks, and Code Division Multiple Access (CDMA) intelligent networks. Each category of intelligent networks has its own set of functions including a service control point (SCP) platform, service scenario, and software for paid services.

Prepaid service is an important service implemented by an intelligent network, mainly aimed to solve the problem of vicious overdraft by users under postpaid circumstances. A prepaid service user has to deposit an amount of money in his/her prepaid account first, and a fee for a call will be deducted in real time from the account during the call. If the money in the account has been used up, initiating a call is not permitted, and the account needs recharging at this time.

Based on the integration of the three categories of networks on an SCP, it is possible to process services of various networks on one SCP platform, which lays a solid foundation for the integration and interoperability of services of fixed intelligent networks, GSM intelligent networks, and CDMA networks.

In the present environment of multiple networks, it is quite common that there are multiple prepaid accounts set up for members of one family. For example, one member of a family may use a prepaid GSM cellular phone, another member may use a prepaid CDMA cellular phone, and yet other one may use a long-distance prepaid phone card. Under such circumstances, every member has an independent account and uses his own charging rate and recharges his own account respectively. If a subscriber of a GSM network desires to use a monthly paid suite service of a CDMA network, or all the members of a family want to share just one account, the existing solutions cannot meet these kinds of demands.

In addition, there is also the same problem in postpaid services that subscribers of different networks cannot share the balance of one account.

### SUMMARY

The present invention is to provide a method for implementing charging in intelligent networks, so that thereby users of different networks may share preferential charging rates and suite services, or share the balance of one account.

The technical solution in accordance with this invention is as follows:

The present invention provides a method for implementing charging in intelligent networks, wherein the method includes:

Step a: configuring an account of a first paid service of an intelligent network as an attached account to an account of a second paid service, and setting an interface for invoking services and an interface for deducting fees in a service control point for the second paid service;

Step b: when the first paid service is to be used by the account of the first paid service, determining whether the account of the first paid service is configured as an attached account to the account of the second paid service, if yes, invoking the interface for invoking services to authenticate the account of the second paid service in the service control point; if the account of the second paid service is authenticated, continuing to perform the following step; otherwise, terminating the procedure; and

Step c: when the first paid service has been used by the account of the first paid service, calculating the fee for the use of the first paid service and invoking the interface for deducting fees configured for the second paid service in the service control point to deduct the calculated fee from the account of the second paid service.

In the above solution, the second paid service may be a prepaid service; and Step a may further include: setting an interface for applying for money for the second paid service, between Step b and Step c, further including: invoking the interface for applying for money configured for the second paid service to decide whether an amount of money could be allocated for the use of the first paid service, if yes, continuing to perform Step c; otherwise, terminating the procedure.

In the above solution, the first paid service may be a Virtual Private Network (VPN) service; and Step a may further include: setting an interface for returning money for the second paid service, after Step c, further including: invoking the interface for returning money for the second paid service to return to the account of the second paid service the money left after deducting the fee of the first paid service from the amount of money allocated for the first paid service.

In the above solution, the first paid service may be a Virtual Private Network (VPN) service; and Step a may further include: setting an interface for returning money for the second paid service, after Step c, further including: invoking the interface for returning money for the second paid service to return to the account of the second paid service the money left after deducting the fee of the first paid service from the amount of money allocated for the first paid service.

In the above solution, the second paid service may be a postpaid service. In the above solution, the second paid service may be a service provided with preferential charging rates.

In the above solution, configuring an account of a first paid service as an attached account to an account of a second paid service in Step a, may include: modifying the service information identity of the account of the first paid service; and determining whether the account of the first paid service is configured as an attached account to an account of the second paid service in Step b, may include: according to the service information identity of the account of the first paid service, deciding whether the account of the first paid service is configured as an attached account to an account of the second paid service.

In the above solution, the second paid service may be a prepaid service in a Code Division Multiple Access (CDMA) network and the first paid service may be a prepaid service in a Global System for Mobile communications (GSM) network.

Compared with existing solutions, this invention makes it possible for other networks' services to call a paid service of this network by configuring appropriate invocation interfaces for the paid service, such as interfaces for invoking services, applying for money, and deducting fees, thereby making suite services, balances, and preferential charging rates shared among users of multiple networks, and making it possible for multiple users to share the balance of one account.

### BRIEF DESCRIPTION OF THE DRAWINGS

FIG. 1 is a flowchart of an embodiment of the invention in which a PPS service of a GSM network invokes a PPC service of a CDMA network.

### DETAILED DESCRIPTION OF PREFERRED EMBODIMENTS

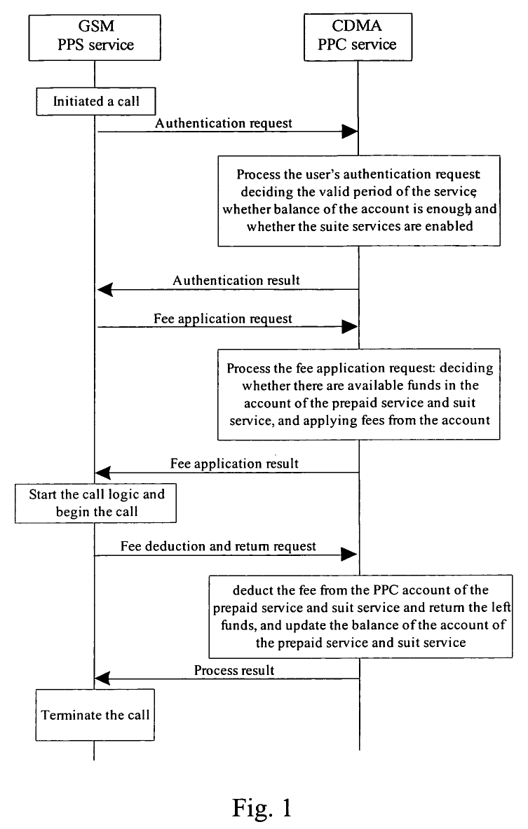

The invention is hereinafter described in detail with reference to an exemplary embodiment and the accompanying FIG. 1.

After a user subscribes to a service, a service invocation mechanism in accordance with the invention could be employed to realize suite services and account balances shared among users of different networks. Service invocation is similar to invoking functions, i.e., defining each independent function of a service as a module similar to a mathematical function, and publishing such modules by means of configuring interfaces so that these modules could be invoked by other services. The contents of the interfaces may be extended according to the demands of the services of the network made by services of other networks. In this way, services of other networks may use the functions of the network's services by invoking these interfaces if need.

In accordance with the invention, when a user is applying for a prepaid service account, the user may attach another prepaid service accounts of the network or extra-networks to the prepaid service account the user currently applies for which can be called a main account. For an attached account, if terminals of a corresponding type are provided, the attached account can be used. The users of the attached accounts may invoke the corresponding functions of the main account's service by using the above configured interfaces, implementing charging the main account and making the users of the attached accounts able to enjoy suite services and preferential charging rates of the main account. The main account may be an account in an intelligent network of a GSM network, a CDMA network, or a fixed network. In accordance with the invention, each attached account's user or the main account's user may recharge the main account and immediately share the balance of the main account after that, which brings much convenience to users.

The specific implementation of the invention is hereinafter described in detail by an example in which a prepaid service of GSM networks (PPS) uses a prepaid service of CDMA networks (PPC).

In order to implement charging in an account of the PPC service when using the PPS service, first, in accordance with the invention, configure the account of the PPS service as an attached account of a PPC service account by means of modifying the service information identity of the PPS service user, thereby making the account of the PPC service as a main account and the account of the PPS service as an attached account to the main account. Set various interfaces related with charging the PPC service in an SCP. These interfaces include:

1. Interface for Invoking Service:

When a PPS service of a GSM network desires to use a PPC service, it is most likely to use the information of the money and the monthly-paid suite services of the prepaid account. Based on the features of prepaid services, however, to use the money information of a prepaid service account, the account of the prepaid service should be authenticated. In order to authenticate a prepaid service account in the PPC service, an interface for invoking services is configured for the PPC service, i.e., defined in the PPC service logic provided in the SCP. If a PPS service or any other service of other networks invokes the interface, authentication of the prepaid service account can be implemented in the PPC service. Typically, the authentication includes: the balance of a prepaid service account, the valid period thereof, the lowest threshold thereof, the valid period of suite services, the balance of monthly-paid suite services, the purview for using suite services, and etc.

2. Interface for Applying for Money:

It is likely that the balance and monthly-paid suite services of a prepaid service account are used by multiple applications of a user or by multiple users simultaneously. It is therefore necessary to apply for fees before using the money of the prepaid service account, i.e., the balance of the account cannot be used until an appropriate amount of money or a monthly-paid suite service has been allocated. In order to deduct fees from a main account corresponding to a PPC service in charging a PPS service, an interface for applying for money is configured in the PPC service logic, and in the interface, the information that needs to be transferred when a user applies for money is also defined, e.g., a number of a user's account for providing money, an amount of money required to be applied for, an ID for invoking service, and etc, thereby applying for the amount of money of the prepaid service account by invoking the interface for applying for money in the PPC service. In other embodiments of the invention, if the main account is not a prepaid service account, the interface for applying for money may not be set, which does not affect the implementation of the invention.

3. Interface for Deducting Fees:

After a prepaid service uses the money of an extra-network prepaid service account or an extra-network monthly-paid suite service, it is necessary to deduct fees from the extra-network prepaid service account or the account of the monthly-paid suite service in real time so as to ensure the correctness of the balance of the prepaid service account. Therefore, in order to deduct fees from a main account corresponding to a PPC service in charging a PPS service, an interface for deducting fees is set in the PPC service logic, and in the interface, interface parameters for notifying the prepaid service to deduct fees are also defined. The interface parameters may include any of the following information, such as a number of a user's account for providing money, the fee that should be deducted, and the ID for invoking deduction. The interface parameters may be selected from the above information as needed, thereby realizing deducting fees by invoking the interface for deducting fees.

4. Interface for Returning Money:

In an embodiment of the invention, if an account corresponding to a Virtual Private Network (VPN) service is taken as an attached account, after the VPN service has applied for an amount of money of a prepaid service and the fee of the VPN service has been deducted from the amount of money, the money left after the deduction should be returned to the main account so as to ensure the correct balance in the main account. It is therefore needed to configure an interface for returning money in the PPC service logic so as to return the left money to the main account by invoking the interface. In the interface, interface parameters for returning money are defined including: the number of the user's account for providing money, an amount of money that should be returned, and the ID of invoking returning fees.

The above interfaces are configured on an SCP of prepaid services which are able to use the interfaces, and the interfaces are a part of the intelligent service. An SCP is a control center of intelligent network services and also an operating platform of various intelligent services. In the embodiments of the invention, both PPC and PPS services are implemented by running on an SCP.

After defining the above interfaces, it is possible to deduct fees from a main account corresponding to a PPC service by invoking the interfaces during the use of a PPS service, therefore users may enjoy the preferential charging rates provided by the PPC service. As shown in FIG. 1, the implementing procedure thereof includes specifically:

Step A: A user of a GSM PPS service initiates a call, a switching device sends a message to an SCP, and the SCP decides by analyzing whether the user has subscribed to the PPS service. And if yes, the SCP starts the PPS service logic to process the current call.

Step B: In the PPS service, based on the service information identity of the PPS user, the PPS service logic decides whether the account of the user is attached to an account of a PPC service and the user desires to use the money in a PPC prepaid service account. That is, the PPS service logic decides whether the PPS user has enabled a charging feature of sharing accounts, e.g., permitting the account shared among multiple applications of a user or among multiple users simultaneously, wherein the PPS user's account is attached to an account of a PPC service and fees for all the PPS calls should be deducted from the PPC service account via the interfaces. If the above decision is yes, the PPS service logic initiates a service call to the PPC service logic, invoking an interface for invoking services configured for the PPC service and authenticating the PPC prepaid service account: deciding whether the PPC prepaid service account of the user is effective, including deciding the valid period of the service, balance of the account, state of the prepaid service account, and purview of suite services. If the PPC prepaid service account is authenticated successfully, i.e., making a decision that the PPC service account is effective, send the authentication result to the PPS service logic, and perform Step C. If the authentication fails, return a message of failure and terminate the current call.

Step C: After determining that the PPC service account is effective, the PPS service logic re-initiates a money application request to the PPC service logic. Upon receiving the request, the PPC service logic invokes the above-mentioned interface for applying for money, allocates an appropriate amount of money for the call, and returns a result of the money application to the PPS service logic.

Step D: On receiving the result of a successful money application, the PPS service logic starts its call logic. The call begins, and the PPS service logic monitors the call. After the user hangs up, the PPS service logic calculates and obtains the fee of the call, and then, returns a fee deduction and return request to the PPC service logic. After receiving the request, the PPC service logic invokes the interface for deducting fees set in the PPC service logic to deduct the fee from the PPC service account, and terminates the call after deducting the fee successfully.

Wherein, if it is a VPN service that applies for an amount of money from an account of the prepaid service, after deducting the fee from the prepaid service account, the VPN service will also invoke the interface for returning money to give back the left part of the money to the prepaid service account, thereby ensuring the correct balance of the prepaid service account.

In the above embodiments, if the main account is not a prepaid service account, the above step of invoking the interface for applying for money may not be performed, which does not affect the implementation of the invention.

The invention is also applicable for intelligent postpaid services. For example, a higher-level CDMA postpaid service account may be used as a main account to which a lower-level PPS service account is attached, by invoking interfaces, the main account, the CDMA postpaid service account, is debited for all the fees generated by the calls which is originated by the PPS service account, and it is only necessary for the main account user to pay the fees. In this case, an interface for invoking services and interface for deducting fees are configured on the postpaid service logic of an intelligent network. When services of other networks use the network's postpaid service, authentication for the postpaid service is made by invoking the interface for invoking services; after the postpaid service is authenticated, start the call, and upon detecting the hang-up, call the interface for deducting fees so as to charge the fee that is generated from the call in the postpaid service account and deduct the fee. The specific implementation method here is similar to the above mentioned implementation method, therefore, no detailed description is given again.

As seen from the above embodiments, a service invocation mechanism in accordance with the invention is employed to implement the invocation of the service authentication, money application, and fees deduction in the network's service by services of other networks, thereby making the suite services and balances shared among service users of the network and other networks so that users of different networks are able to enjoy each other's preferential charging rates and suite services, or to share the balance of one account, which brings much convenience to the users.

The foregoing is only a preferred embodiment of the solution of the invention and is not for limiting the protection scope of the invention.

1. A method for implementing charging in intelligent networks, wherein the method comprises:
Step a: configuring an account of a first paid service of an intelligent network as an attached account to an account of a second paid service, and setting an interface for invoking services and an interface for deducting fees in a service control point for the second paid service;
Step b: when the first paid service is to be used by the account of the first paid service, determining whether the account of the first paid service is configured as an attached account to the account of the second paid service, if yes, invoking the interface for invoking services to authenticate the account of the second paid service in the service control point; if the account of the second paid service is authenticated, continuing to perform the following step; otherwise, terminating the procedure; and
Step c: when the first paid service has been used by the account of the first paid service, calculating the fee for the use of the first paid service and invoking the interface for deducting fees configured for the second paid service in the service control point to deduct the calculated fee from the account of the second paid service.

2. The method according to claim 1, wherein, the second paid service is a prepaid service; and Step a further comprises: setting an interface for applying for money for the second paid service,
between Step b and Step c, further comprising: invoking the interface for applying for money configured for the second paid service to decide whether an amount of money could be allocated for the use of the first paid service, if yes, continuing to perform Step c; otherwise, terminating the procedure.

3. The method according to claim 1, wherein, the first paid service is a Virtual Private Network (VPN) service; and Step a further comprises: setting an interface for returning money for the second paid service;
after Step c, further comprising: invoking the interface for returning money for the second paid service to return to the account of the second paid service the money left after deducting the fee of the first paid service from the amount of money allocated for the first paid service.

4. The method according to claim 1, wherein the second paid service is a postpaid service.

5. The method according to claim 1, wherein the second paid service is a service provided with preferential charging rates.

6. The method according to claim 1, wherein, configuring an account of a first paid service as an attached account to an account of a second paid service in Step a, comprises: modifying the service information identity of the account of the first paid service; and
determining whether the account of the first paid service is configured as an attached account to an account of the second paid service in Step b, comprises: according to the service information identity of the account of the first paid service, deciding whether the account of the first paid service is configured as an attached account to an account of the second paid service.

7. The method according to claim 1, wherein the second paid service is a prepaid service in a Code Division Multiple Access (CDMA) network and the first paid service is a prepaid service in a Global System for Mobile communications (GSM) network.

8. The method according to claim 2, wherein, the first paid service is a Virtual Private Network (VPN) service; and Step a further comprises: setting an interface for returning money for the second paid service;
after Step c, further comprising: invoking the interface for returning money for the second paid service to return to the account of the second paid service the money left after deducting the fee of the first paid service from the amount of money allocated for the first paid service.
